(19) United States
(12) Patent Application Publication
(10) Pub. No.: US 2025/0206848 A1
(43) Pub. Date: Jun. 26, 2025

(54) METHOD FOR MANUFACTURING CELLULOSE NANOCRYSTALS

(71) Applicants: INSTITUT POLYTECHNIQUE DE GRENOBLE, Grenoble (FR); CENTRE NATIONAL DE LA RECHERCHE SCIENTIFIQUE, Paris (FR)

(72) Inventors: Julien BRAS, Saint Martin D’Uriage (FR); Naceur BELGACEM, Brie Et Angonnes (FR); Loreleï DOUARD, Grenoble (FR)

(21) Appl. No.: 18/849,287

(22) PCT Filed: Mar. 22, 2023
(86) PCT No.: PCT/EP2023/057368

§ 371 Date: Sep. 20, 2024

(30) Foreign Application Priority Data
Mar. 22, 2022 (FR) 2202544

(51) Int. Cl. C08B 3/22; C08B 3/12

(52) U.S. Cl. CPC C08B 3/22; C08B 3/12

(57) ABSTRACT

The invention relates to a method (1) for manufacturing cellulose nanocrystals (3) comprising preparing (10) a deep eutectic solvent (102) by mixing a quaternary ammonium salt (100) and a hydrogen bond donor compound (101) in a mechanochemical reactor (4), forming (11) a reaction medium (110) comprising cellulosic fibres (2) and the deep eutectic solvent (102), and subjecting the reaction medium (110) to a mechanochemical treatment (12) so as to obtain cellulose nanocrystals (3) from the cellulosic fibres (2). This mechanochemical treatment (12) enables the acidic hydrolysis of the amorphous cellulose and the surface modification of the cellulose nanocrystals (3), while activating this reaction so as to limit the temperature and treatment time in comparison with existing solutions.

### TECHNICAL FIELD OF THE INVENTION

The present invention relates to the field of manufacture of cellulose nanocrystals from cellulosic fibres. It finds a particularly advantageous and non-limiting application in the field of packagings, medical, paper, or composite materials.

### PRIOR ART

Nanocelluloses are so-called “green” materials: bio-sourced, biodegradable and renewable. Nanocelluloses also have very good mechanical properties. They are divided into two categories: cellulose nanocrystals (abbreviated CNC, standing for Cellulose NanoCrystals in English) and cellulose nanofibrils (abbreviated CNF, standing for Cellulose NanoFibers in English). CNCs and CNFs have been the subject of increasing interest in recent decades. Indeed, between 1990 and 2019, publications covering them have grown annually by 29% and 26% per year. These data show the interest of these bio-sourced nanomaterials.

Conventionally, CNCs are manufactured by acid hydrolysis from cellulosic fibres. For this purpose, mineral acids are generally used, such as the acids of formula H₂SO₄, HCl, H₃PO₄ or HBr. Afterwards, the CNCs may be chemically treated in order to functionalise them. The used main chemical treatments are TEMPO oxidation, which enables a creation of carboxylic acid groups-COOH in the C6 position on the cellulose, or the cationisation which induces a positive charge creation at the surface of the CNCs.

Today, the use of cellulose nanocrystals is limited in particular because of their cost. This is explained by their even difficult manufacture on an industrial scale, in particular because of the corrosion of the equipment by the mineral acid, the hydrolytic degradation of the cellulosic materials (reducing yields) and the difficulty in recovering the acid during the treatment of the effluents. Furthermore, these pre-treatments may involve toxic products, thereby reducing the “green” nature of these materials, and could limit their use.

To limit this, several solutions are considered. Organic acids may be used as a replacement for mineral acids. The organic acids are less corrosive and easier to regenerate. These organic acids may be used in aqueous solution or in their liquid form but remains expensive and difficult to recycle.

Another very recent solution involves the use of a new class of solvents that are more environmentally friendly: the deep eutectic solvents. These solvents, which are merely volatile and even non-volatile, allow isolating CNCs while preserving the advantages of organic solvents.

However, their use requires longer treatment times and higher reaction temperatures than those used in the usual processes with mineral acids. Hence, these solutions remain limited to enable an industrialisation of the manufacture of CNCs.

Hence, an object of the present invention is to provide an improved method for manufacturing cellulose nanocrystals, and in particular a method that is more suited to the industrial manufacturing constraints, for example in terms of treatment time, temperature, yield and/or cost.

The other objects, features and advantages of the present invention will become apparent upon examining the following description and the appended drawings. It should be understood that other advantages could be incorporated.

### SUMMARY OF THE INVENTION

To achieve this objective, according to one embodiment, a method is provided for manufacturing cellulose nanocrystals comprising:
providing a deep eutectic solvent obtained by mixing a quaternary ammonium salt and a hydrogen bond donor compound, the hydrogen bond donor compound being able to form the deep eutectic solvent with the quaternary ammonium salt,
in a mechanochemical reactor, forming a reaction medium comprising cellulosic fibres and the deep eutectic solvent,
subjecting the reaction medium to a mechanochemical treatment so as to obtain cellulose nanocrystals of the cellulosic fibres.

Thus, the deep eutectic solvent enables a chemical treatment of the cellulosic fibres which is herein combined with a mechanical treatment in the mechanochemical reactor. This combined mechanochemical treatment enables the acid hydrolysis of the amorphous cellulose and the surface modification of the CNCs, while activating this reaction so as to limit the temperature and the treatment time in comparison with existing solutions. The CNCs may also be functionalised during preparation thereof. Indeed, the hydrogen bond donor may be condensed with the surface groups of the cellulose, and in particular the C6 groups of the cellulose. In particular, this has been observed when the deep eutectic solvent is prepared from a hydrogen bond donor compound comprising at least one carboxylic acid, and preferably two carboxylic acids. Thus, one single step could allow obtaining CNCs as well as functionalisation thereof to confer other properties thereon.

During the development of the invention, it has also been demonstrated that this mechanochemical treatment could achieve higher functionalisation rates and yields than what would be obtained by performing a chemical treatment using a deep eutectic solvent and a mechanical treatment in a temporally dissociated manner. In particular, it has been possible to obtain yields higher than 60% by weight with respect to the initial amount of cellulosic fibres introduced into the reactor.

Hence, the method is improved in comparison with existing solutions implementing only a treatment using a deep eutectic solvent. In particular, the method is more suited to industrial manufacturing constraints, for example in terms of treatment time, temperature and/or cost

### BRIEF DESCRIPTION OF THE FIGURES

The aims, objects, as well as the features and advantages of the invention will appear more clearly from the detailed description of an embodiment of the latter which is illustrated by the following appended drawings, wherein:

FIG. 1 shows a diagram of the manufacturing method, according to an embodiment.

FIG. 2 shows a flowchart of the manufacturing method, according to an embodiment.

FIGS. 3A and 3B show a schematic view of the obtained CNCs, according to two embodiments of the method.

FIG. 4 shows a graph of the yield as a percentage by weight of the manufacturing method as a function of the duration of the mechanochemical treatment, according to an embodiment.

FIG. 5 shows a transmission electron microscopy (TEM) image of the obtained CNCs, according to an embodiment of the method.

FIG. 6 shows an atomic force microscopy (AFM) image of the obtained CNCs, according to an embodiment of the method.

FIGS. 7A and 7B show graphs of the distribution of the dimensions of the obtained CNCs, respectively of their length and their diameter, according to an embodiment of the method.

FIG. 8 shows a ¹³C nuclear magnetic resonance (NMR) spectrum of cellulosic fibres and of the obtained CNCs according to an embodiment of the method.

FIGS. 9A and 9B show an X-ray diffractogram of the obtained CNCs according to two embodiments of the method, in comparison with that of residual fibres.

FIG. 10 shows an FT-IR absorbance spectrum of cellulosic fibres and of the obtained CNCs according to two embodiments of the method.

The drawings are given as examples and do not limit the invention. They constitute schematic representations of principle intended to facilitate understanding of the invention and are not necessarily plotted to the scale of practical applications. In particular, the relative dimensions between the CNCs, the cellulosic fibres, the reactor, are not representative of reality.

### DETAILED DESCRIPTION OF THE INVENTION

Before starting a detailed review of embodiments of the invention, optional features are set out hereinafter, which could possibly be used in combination or alternatively.

According to one example, the method comprises preparing the deep eutectic solvent by mixing the quaternary ammonium salt and the hydrogen bond donor compound, the hydrogen bond donor compound being able to form the deep eutectic solvent with the quaternary ammonium salt.

According to one example, the quaternary ammonium salt is choline chloride. Indeed, during the development of the invention, it has been demonstrated that choline chloride was particularly suited to the formation of the deep eutectic solvent to obtain the nanocrystals.

According to one example, the hydrogen bond donor compound comprises at least one carboxylic acid group. Indeed, a carboxylic acid group allows obtaining a deep eutectic solvent can induce a functionalisation of the C6 carbon of the cellulose.

According to one example, the hydrogen bond donor compound comprises at least two carboxylic acid groups. Two carboxylic acid groups on the hydrogen bond donor allow obtaining a deep eutectic solvent introducing a carboxylic group-COOH on the C6 carbon of the cellulose by condensation to form an ester bond. At a neutral and/or basic pH, this allows introducing anionic groups on the CNCs and therefore improving their stability. This solution allows obtaining, in one single step, the CNCs while functionalising them and thus conferring new properties on the CNCs. Hence, the method enables the manufacture of functionalised cellulose nanocrystals.

According to one example, upon completion of the mechanochemical treatment, the cellulose nanocrystals have an amount of carboxylate group higher than 100 μeq/g of cellulose nanocrystals. The amount of carboxylate group may be substantially lower than 3,000 μeq/g of cellulose nanocrystals. Preferably, the amount of carboxylate group may be substantially equal to 1,500 μeq/g of cellulose nanocrystals. Thus, a good stability of the CNCs is obtained, thanks to the mechanochemical treatment by the NADES prepared from a hydrogen bond donor compound comprising at least two carboxylic acid groups.

According to one example, the hydrogen bond donor compound is selected from the group consisting of citric acid and oxalic acid, preferably the hydrogen bond donor compound is oxalic acid. The mechanochemical treatment resulting from the deep eutectic solvent derived from citric acid or oxalic acid, in particular with choline chloride, allows increasing the yield and the degree of functionalisation of the CNCs. In comparison with citric acid, oxalic acid has a lower pKa and thus allows further improving the yield and the properties of the obtained CNCs.

According to one example, at least one carboxylic group of the hydrogen bond donor compound has a pKa lower than or equal to 4.

According to one example, the mass proportion of cellulosic fibres in the reaction medium formed with the deep eutectic solvent is higher than or equal to 30%, preferably higher than or equal to 35%, and even more preferably substantially equal to 38%, this proportion being calculated by m_{fibre}/(m_{fibre}+mₛₒₗᵥₑₙₜ). The mass ratio m_{fibre}/mₛₒₗᵥₑₙₜ may be higher than or equal to 40%, preferably higher than or equal to 50%, and more preferably substantially equal to 60%. A large proportion of fibres may be used in a mechanochemical reactor, in comparison with other mechanical techniques like with extrusion for example.

According to one example, during the mechanochemical treatment, the reaction medium is free of any additional solvent. In one example, the compounds necessary for the formation of the deep eutectic solvent as well as the cellulose fibres are provided in the form of powders, without any additional solvent, in the mechanochemical reactor. The mechanochemical reactor allows, through a mechanochemical treatment, forming the reaction medium and manufacturing the cellulose nanocrystals. Hence, the method does not require an additional pre-treatment step. According to one example, at least during the mechanochemical treatment, the reaction medium comprises only cellulosic fibres and the deep eutectic solvent, as well as the reaction products derived from this treatment.

According to one example, the mechanochemical treatment is configured to obtain a CNC mass yield higher than or equal to 50%, preferably higher than or equal to 60% relative to the initial amount of cellulosic fibres introduced into the reactor 4.

According to one example, the mechanochemical treatment is performed for a period shorter than or equal to 2 hours. Thus, the treatment time is limited in comparison with existing solutions, reducing the cost and further improving the compatibility of the method with industrial constraints.

According to one example, the mechanochemical treatment is performed at a temperature comprised between 15° C. and 30° C., preferably substantially equal to 25° C. Thus, the treatment temperature is limited in comparison with existing solutions, herein also reducing the cost and further improving the compatibility of the method with industrial constraints. According to one example, the method does not comprise a step of heating the reaction medium at least during the mechanochemical treatment. In an example, during the mechanochemical treatment, the temperature of the reaction medium is maintained by a temperature regulation device, at a temperature lower than or equal to 30° C., preferably at 25° C.

According to one example, the formation of the reaction medium is performed at a temperature comprised between 15° C. and 30° C., preferably substantially equal to 25° C. Thus, the treatment temperature is limited in comparison with existing solutions, herein also reducing the cost and further improving the compatibility of the method with industrial constraints. According to one example, the temperature of the reaction medium during the mechanochemical treatment is lower than 50° C., preferably lower than 40° C. According to one example, the method does not comprise a step of heating or regulating the temperature of the reaction medium at least during the mechanochemical treatment. The temperature of the reaction medium may rise, in particular up to 40° C. or 50° C., because of the mechanical stresses and the chemical reactions in the reaction medium. The temperature values of the reaction medium should be understood as an overall temperature value of the reaction medium. At some local points of the reaction medium, the temperature may be punctually higher.

According to one example, the mechanochemical reactor is a mechanochemical mill, for example a bead mill.

According to one example, the mechanochemical treatment is performed at a vibration frequency comprised between 5 Hz and 100, preferably between 5 Hz and 50 Hz, preferably substantially equal to 30 Hz.

According to one example, after the mechanochemical treatment, the method comprises washing the reaction medium. The washing allows reducing the amount of, and even eliminating, the deep eutectic solvent of the reaction medium. For this purpose, the washing may be done with a washing solvent distinct from the deep eutectic solvent. The washing solvent may be an aqueous solution, and preferably water.

According to one example, the washing is done by dialysis of the reaction medium through a dialysis membrane. Thus, the deep eutectic solvent may be replaced by the dialysis solvent to facilitate the subsequent use of the CNCs, whether functionalised or not. Preferably, the dialysis of the reaction medium is done with an aqueous solution, and preferably water.

According to one example, after the mechanochemical treatment, and where appropriate after washing of the reaction medium, the method comprises a separation of the reaction medium into a first fraction comprising the cellulose nanocrystals and a second fraction comprising residual fibres. Thus, the first fraction comprising the cellulose nanocrystals is recovered separately from the second fraction. Hence, the obtained CNCs are purer.

According to one example, upon completion of the mechanochemical treatment, and preferably before washing the reaction medium, the reaction medium comprises a mass fraction of cellulose nanocrystals higher than or equal to 20%, preferably higher than or equal to 40%.

According to one example, the separation of the reaction medium comprises a centrifugation of the reaction medium followed by a sampling of one amongst the first and second fractions, for example the first fraction.

According to one example, the second fraction is recovered for use thereof in a method for manufacturing cellulose nanofibres. Thus, the method enables a revalorisation of the residual fibres for CNF manufacturing.

According to one example, the mechanochemical reactor comprises an enclosure so-called a grinding chamber, in which the reaction medium is formed, and grinding elements scattered in the formed reaction medium.

Several embodiments of the invention implementing successive steps of the manufacturing process are described hereinafter. Unless explicitly mentioned, the terms “successive”, “after”, “following” and their equivalents do not necessarily imply, even though this is generally preferred, that the steps follow one another immediately, intermediate steps could separate them.

Moreover, the term “step” should be understood as the completion of a portion of the method, and could refer to a set of sub-steps.

Moreover, the term “step” does not necessarily mean that the actions carried out during a step are simultaneous or immediately successive. In particular, some actions of a first step may be followed by actions related to a different step, and other actions of the first step could be carried on afterwards. Thus, the term “step” does not necessarily mean unitary that are inseparable actions over time and in the sequence of the phases of the method.

By compound or material “based on” a material A, it should be understood a compound or material comprising this material A, and possibly other materials.

The word “bio-sourced” refers to materials of natural origin, for example derived from renewable resources, and more particularly materials derived from biomass of animal, algal or plant origin.

By “cellulose” or “cellulose fibres”, it should be understood a polysaccharide which forms the main constituent of the cell wall of plant tissues and which contributes to their support and their rigidity. The cellulose originates from wood (which constitutes the main source), cotton (whose fibres are almost pure cellulose), flax, hemp and other plants. It is also a constituent of several algae and of a few mycetes.

It is known to form cellulose nanocrystals from natural cellulose fibres, and in particular from cellulose fibres derived from softwood or hardwood pulps. Cellulose nanocrystals are naturally present in cellulosic fibres in the form of crystalline domains and typically comprise at least 50% of the number of nano-objects, and typically CNCs are nano-objects (i.e. objects at least one of the dimensions of which is between 1 and 100 nanometres-nm). Cellulose nanocrystals (CNC) are also commonly called crystalline nanocellulose, cellulose nanocrystals, nanocrystalline cellulose and still cellulose nanowhiskers. The CNCs typically have a diameter comprised between 1 and 50 nm and a length comprised between 100 nm and 2,000 nm.

Moreover, it is known to form cellulose nanofibres from cellulosic fibres, and in particular from cellulose fibres derived from softwood or hardwood pulps. More particularly, the cellulose nanofibres are in the form of microfibres or microfibrils, MFC or CMF (English acronyms of cellulose microfibrils), or nanofibres or nanofibrils, NFC or CNF (English acronyms of cellulose nanofibrils). The cellulose micro- or nanofibrils typically have a diameter comprised between 5 and 100 nm and a length comprised between 0.2 and 5 μm. It should be noted that, in the context of the present invention, the terms “nanofibrillated cellulose” or “cellulose nanofibres” are used interchangeably to refer to nanofibrillated cellulose, or cellulose nanofibres (NFC), and microfibrillated cellulose, or cellulose microfibres (MFC).

By a parameter “substantially equal to/higher than/lower than” a given value, it should be understood that this parameter is equal to/higher than/lower than the given value, within a 10% margin, or within a 5% margin, of this value.

By “mechanochemical reactor”, it should be understood a reactor capable of performing a mechanochemistry treatment, i.e. of applying enough forces on the reaction medium to obtain functionalised cellulose nanocrystals. More particularly, these forces are shear, collision and/or friction forces. In a mechanochemical reactor, the collision forces are higher than the shear and friction forces. In a manner known to a person skilled in the art, the term “mechanochemistry” is defined as science using the influence of mechanical actions to produce chemical and physicochemical changes of the substances in all aggregation states. Mechanochemistry is a field of chemistry close to tribochemistry, which consists of the branch of chemistry that deals with chemical reactions in the friction areas. The basic principle of mechanochemistry is that a material subjected to a mechanical action absorbs energy, stores it in a defect point and expands it in different ways which could lead to the rupture of covalent bonds on the macromolecules and to other chemical reactions. The forces applied to the reaction medium in a mechanochemical reactor are such that chemical reactions could occur. The energy supplied locally to the system is higher than the activation energy of the desired chemical reaction. More particularly, in the present invention, focus is made on a weakening of the hydrogen bonds; on the homolytic cleavage of the anhydroglucose units (AGU) as well as to the esterification reaction at the surface of the nanocrystals.

This is not true in the case of a simple extrusion of a reaction mixture, which does not exert enough mechanical force to perform a mechanochemical treatment. During the development of the invention, it has also been demonstrated that a simple extrusion of the reaction medium did not allow manufacturing cellulose nanocrystals. Hence, the term “mechanochemical reactor” excludes a simple extrusion of a reaction medium.

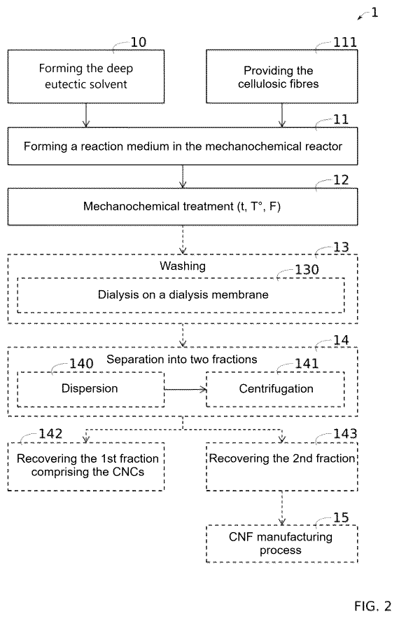

The method 1 is now described in more detail according to several embodiments with reference to the figures. FIG. 2 shows, in dotted lines, optional variants of the method.

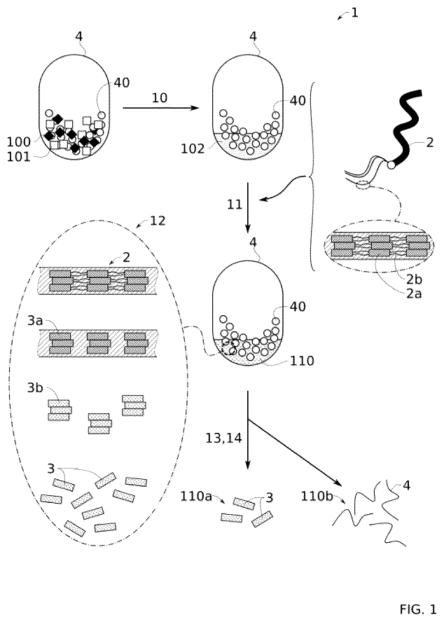

The method 1 comprises providing a deep eutectic solvent 102. Deep eutectic solvents (in English Deep Eutectic Solvents, DES, also referred to as Natural Deep Eutectic Solvents, NADES) are solvents which are increasingly used as a “green” alternative to ionic liquids. The NADES are solvents formed by mixture between at least two solid compounds 100, 101 at a proportion corresponding to the eutectic point. This mixture then behaves like a pure body. In general, the NADES are liquid at room temperature, which facilitates use thereof as a reaction solvent at low temperature, for example at room temperature. It is possible to provide for this solvent being purchased as such from the mixture of the two compounds 100, 101. In one variant, illustrated for example in FIGS. 1 and 2, the method may comprise the preparation 10 of the NADES by mixing.

Afterwards, in a mechanochemical reactor 4, a reaction medium 110 is formed 11 with the NADES and cellulosic fibres 2. The cellulose of the cellulosic fibres 2 comprises crystalline domains 2a which will give the CNCs by the process 1, and amorphous fibrous domains 2b. Afterwards, the reaction medium 110 is subjected to a mechanochemical treatment 12 configured so as to obtain cellulose nanocrystals 3 by hydrolysis from the cellulosic fibres 2. It is possible to consider that the CNC 3 are “extracted” from the cellulosic fibres 2. In particular, the reaction medium is maintained under the experimental conditions of the mechanochemical treatment 12 until obtaining the CNC 3.

Six phenomena occur during the mechanochemical treatment 12, causing morphological, structural and chemical changes in the cellulosic fibres 2. During the first steps of grinding, the NADES 102 penetrates the cellulosic fibres 3 through the defects of the walls. During the same period, the mechanical treatment causes fragmentation of the fibres into micrometric particles. Thus, this fragmentation facilitates the penetration of the NADES 102. The NADES 102 hydrolyses the amorphous portion 2b of the cellulose, thereby reducing its degree of polymerisation and releasing CNC aggregates. Concomitantly, the NADES 102 functionalises the CNC 3, as illustrated by the passage between aggregates 3a and 3b. Finally, mechanical actions enable the disintegration of the CNC 3a, 3b aggregates into individualised CNC 3. It should be noted that, in order to simplify the illustration in FIG. 1, these steps are shown as successive and distinct. In reality, these phenomena can take place in parallel, or more or less successively depending on the progress of the mechanochemical treatment 12 and the level of grinding of the cellulosic fibres 3.

This combined chemical and mechanical action allows facilitating the action of the NADES 102 on the cellulosic fibres 2, by mechanical grinding of the fibres 2 on the one hand and also by supplying energy to the reaction medium 110. Thus, the treatment temperature and time are limited in comparison with the existing solutions. Advantageously, the CNC 3 are functionalised during preparation thereof. Thus, one single step allows obtaining CNC 3 as well as functionalisation thereof to confer other properties thereon. In the mechanochemical treatment, the mechanical treatment is at least partially simultaneous, and preferably totally simultaneous, with the chemical action of the NADES. The method 2 may be free of an additional mechanical treatment of the reaction medium 110.

The mechanochemical treatment 12 may further form residual fibres 4, in particular derived from the amorphous portions 2b of the cellulose.

The mechanochemical reactor 4 is a reactor configured to exert a mechanical stress on the reaction medium 110 that it contains. There are several kinds of mechanochemical reactors that could be used in the context of the invention. According to one example, the mechanochemical reactor 4 is a bead mill 40. It is possible to provide for the mechanochemical reactor being another type of mechanochemical mill, for example a planetary mill. Other types of mechanochemical reactor may be considered by a person skilled in the art. In particular, mention may be made of rotary mills, vibratory mills, friction or stirring mills (commonly referred to as attritors in English), disk refiners, ultrasonic homogenisers, high-pressure homogenisers. Rotary mills, vibratory mills, friction or stirring mills (commonly referred to as attritors in English), are particularly suited to the process in the proportions of fibres described before, because they are suited to mechanochemistry of a more viscous reaction medium, with a high proportion of fibres. In general, most mechanochemical reactors are composed of an enclosure, so-called grinding chamber, and of grinding elements. In general, the grinding chamber and the elements are composed of hard, dense and resistant materials such as sand, stainless steel, silicate and zirconium oxide, yttrium oxide, glass, aluminium and titanium. The material should be selected according to the material to be treated (ductile or brittle materials) and the treatment conditions. The following parameters may have an impact on the mechanochemical treatment, a person skilled in the art being quite capable of finding the relevant parameters to implement the method: (i) the ratio between the mass of the beads and that of the powders; (ii) the speed and the frequency of the device; (iii) the materials of the elements to be ground; (iv) the shape of the grinding chamber; (v) the control or not of the temperature and of the atmosphere. According to one example, the grinding elements loaded into the grinding chamber are spherical-shaped grinding beads. This geometry may be explained by the fact that the spherical shape is the most mechanically stable for grinding.

Next, as a non-limiting example, it is considered that the mechanochemical reactor 4 is a bead mill.

The preparation 11 of the NADES and the mechanochemical treatment 12 may be performed in the mechanochemical reactor 4. Alternatively, the preparation 11 of the NADES may be done prior to introduction thereof into the mechanochemical reactor 4, for example into another mechanochemical reactor 4 or any other element enabling mixing of the compounds 100, 101 to form the NADES. The cellulosic fibres 2 may be introduced into the reactor 4 after the introduction and/or the preparation of the NADES into the reactor 4. Alternatively, it is possible to provide for the compounds 100, 101 being introduced into the reactor 4 to form the NADES and the cellulosic fibres 4, in any order relative to one another, and that, afterwards, mixing of the compounds 100, 101 is performed, in the presence of the cellulosic fibres.

Each step of the method 1 is now described in more detail.

The preparation 11 of the NADES 102 is described at first. The preparation of the NADES is easy in comparison with that of the ionic liquids which require several steps of chemical syntheses and purifications. This consists of a simple mixing of compounds 100, 101 composing the NADES in good proportion, until obtaining a homogeneous liquid. These components are a pair of a hydrogen bond donor and an acceptor of this bond. The table hereinbelow summarises the major types of NADES known today, and the nature of the compounds mixed for formation thereof.

TABLE 1

| NADES type | Mixed compounds |
|---|---|
| Type I | Quaternary ammonium salt + |
| | Metal chloride |
| Type II | Quaternary ammonium salt + |
| | Hydrated metal chloride |
| Type III | Quaternary ammonium salt + |
| | Hydrogen bond donor |
| Type IV | Hydrated metal chloride + |
| | Hydrogen bond donor |

In the context of the present invention, the NADES 102 is a type III NADES, prepared from mixture of a quaternary ammonium salt 100, and a hydrogen bond donor compound 101. The quaternary ammonium salt 100 and the hydrogen bond donor compound 101 are able to form together the NADES. A person skilled in the art knows which compound 100, 101 to select to obtain a type III NADES. Examples are also given hereinbelow.

The quaternary ammonium salt 100 comprises an ammonium cation carrying four groups attached to a nitrogen atom N, and a counterion. For example, the quaternary ammonium salt 100 may comprise the choline cation, associated with a counterion. For example, the quaternary ammonium salt 100 is choline chloride, having the following chemical formula. The choline chloride is preferred because it is non-toxic, low-cost and easy to produce.

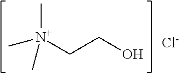

According to other non-exhaustive examples, the quaternary ammonium salt 100 may be tetramethylammonium chloride choline fluoride, N-benzyl-2-hydroxy-N,N-dimethylethanaminium chloride, N-ethyl-2-hydroxy-N,N-dimethylethanaminium chloride, tetra-n-butylammonium bromide, tetra-n-ethylammonium chloride.

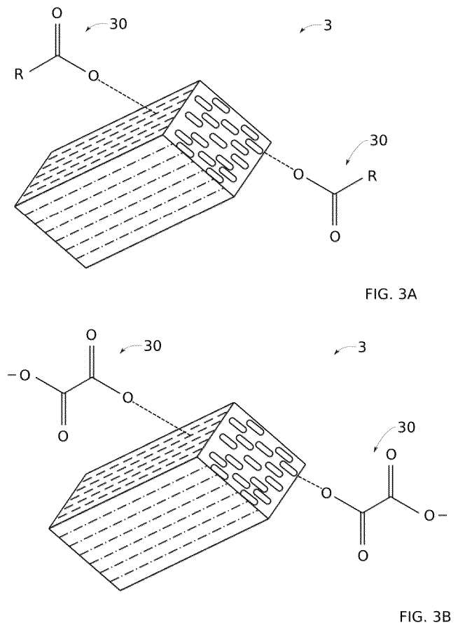

The hydrogen bond donor compound 101 may be any hydrogen bond donor compound able to form a NADES 102 with the quaternary ammonium salt 100. The hydrogen bond donor compound 101 may comprise at least one electronegative atom (for example O, N, F) bonded to a hydrogen atom. For example, the hydrogen bond donor compound 101 may have a hydroxyl function, for example an alcohol, a primary amine or a secondary amine. Preferably, the hydrogen bond donor compound 101 comprises at least one carboxylic acid group. This allows facilitating a good functionalisation of the C6 carbon of the cellulose of the CNC 3, by formation of an ester bond, like for example illustrated by the groups 30 in FIGS. 3A and 3B. In FIG. 3A, for example, a carboxylic acid of formula R—COOH has been used to form the NADES. It is possible to observe a functionalisation of the CNC by the group R via an ester bond. More generally, this example is applicable depending on the used NADES. Hence, one could understand that the properties of the CNC 3 can be modified according to their surface functionalisation.

According to one example, the hydrogen bond donor compound 101 comprises at least two carboxylic acid groups. Thus, a first group may be used for the functionalisation of the CNC 3. The remaining group(s) may form carboxylate groups 30 at the surface of the CNCs so as to improve their stability, as illustrated for example in FIG. 3B following the functionalisation by an NADES formed from oxalic acid. Upon completion of the mechanochemical treatment 12, the CNCs 3 may have an amount of carboxylic group (which could be deprotonated into carboxylate) comprised between 100 and 3,000 μeq/g of CNC, preferably substantially equal to 1,500 μeq/g. The microequivalents □eq are given as a molar amount relative to the mass of CNC. This measurement may be made by conductimetric assay. For this purpose, according to one example, a known amount of CNC is dispersed in a volume of water. Afterwards, the pH of the medium is reduced by adding a known amount of acid. A sodium hydroxide solution is then added to the reaction medium in a successive small amount. At each addition, the conductivity of the medium is measured. Thus, a conductivity curve of the medium is obtained as a function of the added amount of sodium hydroxide. This curve allows deducing the molar amount of carboxylic groups.

According to one example, the hydrogen bond donor compound 101 may be oxalic acid, having the following chemical formula.

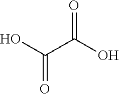

According to one example, the hydrogen bond donor compound 101 may be citric acid, having the following chemical formula.

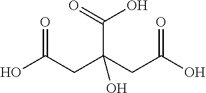 [SMILES: O=C(O)CC(O)(CC(=O)O)C(=O)O]

In comparison with citric acid, oxalic acid has a lower pKa and thus allows further improving the yield and the properties of the obtained CNCs, as illustrated in more detail as example hereinafter. Hence, the oxalic acid is preferably used rather than the citric acid.

Other carboxylic acids can be used to form the NADES 102, such as the malonic acid, the acetic acid, the formic acid or the lactic acid.

The molar ratio between the quaternary ammonium salt 100 and the hydrogen bond donor compound 101 is selected so as to form the eutectic mixture of the NADES 102. Preferably, for the choline chloride-oxalic acid, and choline chloride-citric acid pairs, the molar ratio is 1:1.

The NADES 102 may be prepared by mixing the compounds 100, 101. According to one example, the NADES 102 is prepared by mixing in the mechanochemical reactor 4 under the action of the mechanical stress exerted in the reactor, so as to obtain the NADES in the liquid form. Advantageously, this mixing may be done at room temperature, without controlling the temperature. For example, the temperature obtained in the reactor upon completion of the mechanochemical treatment may be comprised between 40° C. and 50° C. Alternatively, the mixture may be maintained at a given temperature by a temperature regulation device, for example included in the reactor 4.

The reaction medium 110 may be formed 11 by mixture of the NADES 102 and the cellulosic fibres 2. The reaction medium 110 may be free of a solvent added to the NADES, the NADES forming a liquid medium in which the mechanochemical treatment 12 may take place. The solvent of the reaction medium 110 may comprise only the NADES. The mass ratio between the cellulosic fibres 2 and the NADES 102 (m_{fibres}/m_{NADES}) may be comprised between 50% and 63% by weight during the formation of the reaction medium 110.

The cellulosic fibres 2 may be of different kinds. These fibres 2 may be bleached or not. The cellulosic fibres may be ground so as to form fibres commonly so-called fluffy, which corresponds to a dry mechanical treatment, typically grinding, by limiting, and preferably avoiding, a degradation of the fibres and making their surface available. The fibres then have a cellulose or cotton wadding appearance. For example, the cellulosic fibres 2 may consist of cotton fibres.

The formed reaction medium 110 is subjected to the mechanochemical treatment 12, in the mechanochemical reactor 4. The mechanochemical treatment 12 may be performed for a duration t that is sufficient to obtain the CNCs 3 of the cellulosic fibres 2. More particularly, the mechanochemical treatment 12 may be performed for a duration t that is sufficient to reach a mass yield higher than or equal to 50%, preferably higher than or equal to 60%, relative to the initial amount of cellulosic fibres introduced into the reactor 4. According to one example, this duration is shorter than or equal to 2 hours, and preferably longer than or equal to 0.5 hour. Indeed, the treatment time required to obtain the CNC 3 may be limited thanks to the mechanochemical action. During the development of the invention, times of 0.5, 1 h and 2 h have been tested, as described later on with reference to the particular examples.

The mechanochemical treatment 12 may be performed at a temperature T° comprised between 15° C. and 30° C., preferably substantially equal to 25° C. The mechanochemical treatment 12 may be done without regulating the temperature, and therefore at room temperature (about 25° C.). The temperature of the reaction medium 110 may be comprised between 40° C. and 50° C. upon completion of the mechanochemical treatment. Alternatively, the mechanochemical treatment 12 may be done by regulating the temperature by a temperature regulation device, for example as described before. The temperature may be regulated at a temperature lower than 30° C. Indeed, the mechanochemical action is sufficient to obtain and functionalise the CNC 3 without having to heat the reaction medium 110 at higher temperatures to supply energy to this medium.

Finally, the mechanochemical treatment may be performed at a vibration frequency F that is sufficient to obtain CNC 3 from the cellulosic fibres 2, and that being so preferably in the time ranges t indicated hereinabove. More particularly, the frequency F may be selected so as to reach a mass yield higher than or equal to 50%, preferably higher than or equal to 60%, relative to the initial amount of cellulosic fibres introduced into the reactor 4. For this purpose, the vibration frequency may in particular be comprised between 5 Hz and 100 Hz, preferably comprised between 5 Hz and 50 Hz, more preferably substantially equal to 30 Hz.

The washing 13 is now described. Washing 13 of the reaction medium 110 may be performed upon completion of the mechanochemical treatment. The washing 13 may be configured to reduce the amount, and possibly eliminate, the NADES 102 of the reaction medium 110. For this purpose, the washing may be done with a washing solvent distinct from the NADES 102. The NADES 102 being electrically-conductive, the washing may be done so as to approach, and preferably make substantially equal, the conductivity of the reaction medium 110 from that of the washing solvent. For example, the washing solvent may be an aqueous solution, and for example water.

According to one example, washing 13 of the reaction medium 110 is done by dialysis 130 of the reaction medium 110. The dialysis 130 may be performed until approaching, and preferably makes making substantially equal, the conductivity of the reaction medium 110 from that of the washing solvent. For this purpose, the dialysis 130 may be performed on a dialysis membrane. Preferably, the dialysis membrane has a cut-off threshold selected so as to let the ions of the NADES pass, while blocking the passage of the prepared CNCs. In particular, the membrane may have a cut-off threshold comprised between 6 kDa and 8 kDa (with 1 Da≈1 g/mol).

After the mechanochemical treatment 12, and preferably after the washing 13, the method 1 may comprise a step 14 of separating the reaction medium 110 into two fractions. The first fraction 110a then comprises the cellulose nanocrystals 3. The second fraction 110b may comprise residual fibres 4. Thus, the first fraction 110a comprising the CNC 3 is recovered separately from the second fraction 110b. An example of separation is described hereinbelow as a non-limiting example. It should be noted that any other separation method may be considered.

The separation 14 may comprise a dispersion 140 of the reaction medium 110. The dispersion 140 may be done by sonication. The dispersion allows re-suspending the CNC 3 in the medium 110, which then form a colloidal suspension that is stable in solution.

The separation 14 may comprise, preferably following the dispersion 140, a centrifugation 141 of the reaction medium so as to precipitate the elements present in the reaction medium other than CNC 3. In particular, this allows precipitating the residual fibres 4. Thus, the first fraction 110a may correspond to the supernatant upon completion of the centrifugation 141, and the second fraction 110b may correspond to the slag. It should be noted that the separation 14 may comprise the centrifugation 141 with no prior dispersion 140.

The first fraction 110a may be recovered 142. Thus, the isolated CNCs are obtained from the residual fibres 4. For example, the supernatant may be sampled upon completion of the centrifugation 141. The second fraction 110b may be recovered 143. Afterwards, the second fraction 110b comprising the residual fibres may be used in a CNF manufacturing process 15. For this purpose, the second fraction 110b may for example be left to rest to sediment part of the residual fibres 4. Preferably, the sedimented fibres are then used in a CNF manufacturing process 15.

### Particular Examples

Two particular embodiments of the method 1 are now described.

In these examples, the cotton fibres are bleached and mechanically treated cotton fibres, commercially available and originating from the papermaking industry. This pulp has been fluffed under dry conditions at room temperature using a Forplex® apparatus.

The bead milling process is carried out using a vibrating bead reactor 4 (CryoMill®, Retsch GmbH). The grinding chamber (20 ml) and the beads 40 are made of zirconium dioxide (ZrO₂). The beads are 50 in number, and their diameter is 5 mm.

In these examples, the hydrogen bond donor 101 is either citric acid (CAM) or oxalic acid (OAD), depending on the example. The quaternary ammonium salt 100 is choline chloride (ChCl). These two compounds 100, 101 have been added to the grinding chamber of the reactor 4 with 50 zirconium beads and ground at 30 Hz. After only 15 seconds of grinding, the two NADES ChCl: OAD (molar ratio 1:1) and ChCl: CAM (molar ratio 1:1) can be obtained and cover the surface of the beads and of the grinding chamber. The masses added to the grinding jar allow obtaining 3 mmol of NADES and are given in the table hereinbelow.

TABLE 2

| | Choline | Hydrogen | NADES |
|---|---|---|---|
| | chloride | bond donor | (in g, |
| | (ChCl) | CAM or OAD | equivalent |
| NADES | (in g) | (in g) | to 3 mmol) |
| ChCl:OAD | 0.42 | 0.38 | 0.8 |
| (1:1) | | | |
| ChCl:CAM | 0.42 | 0.58 | 1.0 |
| (1:1) | | | |

For the two examples, 0.5 grams of cotton fibres (percentage of dry matter=94%) are added to the grinding chamber containing the NADES and ground at 30 Hz. After 3 and 5 minutes of treatment, the grinding chamber is open and the cellulosic material is homogenised. Finally, the mechanochemical treatment 12 is performed for a total treatment time of 0.5, 1 or 1.5 hour(s).

After the mechanochemical treatment 12, about 5 ml of water are added into the grinding chamber, and 15 seconds of grinding at 30 Hz are performed to disperse the treated fibres. Afterwards, the suspension is recovered and dialysed with deionised water until the conductivity of the sample is the same as that of deionised water (molecular weight threshold of the dialysis membrane: 6-8 kDa). Afterwards, the suspension has been sonicated using a 250 watt sonication probe (Sonifer® 250, Branson) with a dispersive energy of about 4.22 KJ per g of materials. Afterwards, the suspension has been centrifuged for 10 minutes at 2,600 g at 20° C. Finally, the supernatant containing the stable colloidal CNCs 3 has been removed and stored in the refrigerator. The mass concentration of the CNC suspension is then 0.2%. The precipitate containing the residual cellulosic fibres (denoted RP hereinafter) has been dispersed in deionised water and stored in the refrigerator. After one week of sedimentation, two distinct suspensions have been obtained: one containing sedimented particles (denoted SP hereinafter) and the second one non-sedimented particles (denoted nSP hereinafter).

The CNC samples are so-called “CNC-ChCl: OAD-MC” and “CNC-ChCl: CAM-MC” for the CNCs obtained by the method using the NADES ChCl: OAD and ChCl: CAM, respectively. The CNC-ChCl: OAD-MC are obtained with three different treatment times (0.5, 1 and 1.5 hours). The characterisations other than the yield have been carried out for only 1.5 hours of mechanochemical treatment. The experimental conditions are summarised in the table hereinbelow. For comparison, CNC samples obtained by NADES with no mechanochemical treatment (CNC-ChCl: OAD and CNC-ChCl: CAM) are described in the table hereinbelow

TABLE 3

| | | Mass yield | | | |
|---|---|---|---|---|---|
| | | of the CNC | | | |
| | | obtained in | | | |
| | | the NADES | | | Mechano- |
| | | after | | | chemical |
| | Time, | treatment | | | treatment |
| Sample | (h) | (% wt) | Temperature | | (MC) |
| CNC-ChCl:OAD- | 0.5 | 14% | Ambient with | | Yes |
| MC | 1 | 49% | no regulation of | | |
| | 1.5 | 65% | the temperature | | |
| CNC-ChCl:CAM- | 1.5 | 27% | | | |
| MC | | | | | |
| CNC-ChCl:OAD | 6 | 36% | 95° | C. | No |
| CNC-ChCl:CAM | 6 | 8% | 120° | C. | No |

The CNC 3, the sedimented particles (SP) and the non-sedimented particles (nSP) have been separated after washing, which allowed determining the yield of each obtained suspension. The CNC yield (Y_{CNC}) is calculated as the ratio between the weight of the CNC (m_{CNC}) and the initial weight of the cellulosic fibres (m₀), as expressed in the following equation.

$${Y}_{CNC} ( \% ) = \frac{{m}_{CNC}}{{m}_{0}} \times 100$$

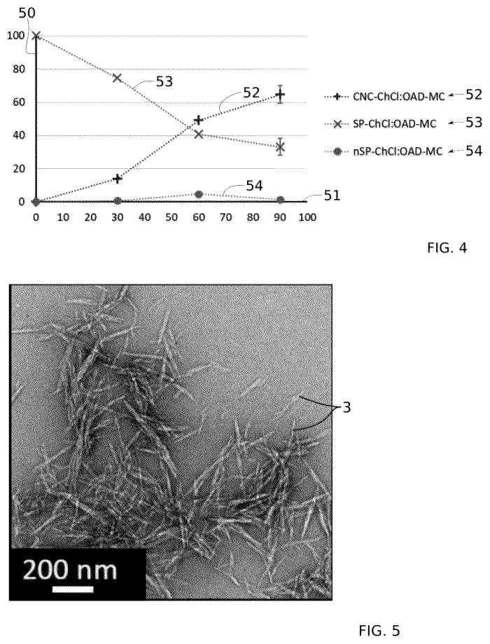

The evolution of the CNC yield Y_{CNC} 50 as a function of the duration 51 of the mechanochemical treatment 12 is illustrated in FIG. 4 for:
52: the CNC-ChCl: OAD-MC,
53: the sedimented particles SP obtained by the method for manufacturing the CNC-ChCl: OAD-MC,
54: non-sedimented particles nSP obtained by the method for manufacturing the CNC-ChCl: OAD-MC.

CNCs with a yield of 64.5±5.3% have been successfully obtained after only 1.5 hours of treatment using the NADES ChCl: OAD (the initial concentration of the fibres in the reactor 4 is about 62%).

For the CNC-ChCl-CAM-MC sample, the yields obtained after 1.5 hours are 27.1% for the CNCs, and 0.7% and 79.8% for the residual particles nSP and SP, respectively. Lower CNC yields are obtained in comparison with the ChCl-OAD-MC treatment. This result confirms that the acid hydrolysis of the amorphous portion of the cellulose is more effective with the oxalic acid than with the citric acid.

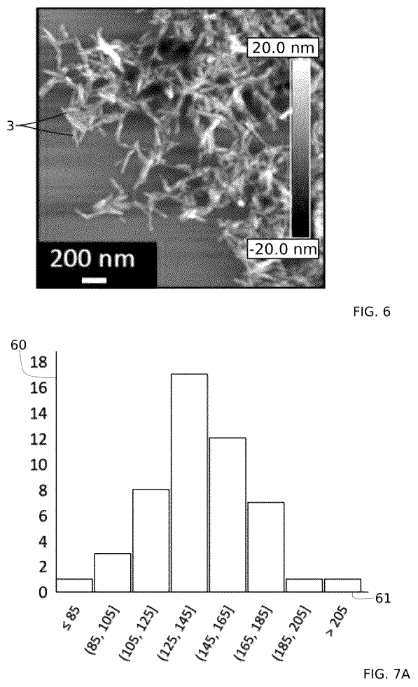

The dimensions of the produced CNCs after 1.5 hours of mechanochemical treatment have been analysed by SEM and by AFM, as illustrated respectively in FIGS. 5 and 6. The CNC-ChCl: OAD-MC have conventional dimensions for cotton cellulose nanocrystals with lengths and diameters of 143±28 nm and 7±2 nm, respectively. FIGS. 7A and 7B respectively illustrate distribution diagrams of the occurrence 60 respectively as a function of the length (in nm) 61 and of the diameter (in nm) 62.

The Zeta potential ζ of the CNC suspensions has been measured with a Zetasizer® PRO (Malvern Panalytical®) apparatus. The folded capillary cell is maintained at 20° C. during the measurement. 1 mL of the CNC sonicated suspension has been diluted by adding 8 mL of deionised water and 1 mL of NaOH solution (C=0.0125 mol/L) to adjust the pH and the conductivity of the sample. Three series of measurements of ten acquisitions have been performed for each sample, and the average value is calculated.

The measurement of the Zeta potential Z confirmed the assumption of the surface functionalisation of the CNCs. A high value of the surface charges is observed for the two CNCs with the treatments ChCl: CAM-MC and ChCl: OAD-MC. Thus, this method allows obtaining anionic particles with Zeta potential values of −42.0±3.3 mV and −41.2±1.6 mV for the ChCl: CAM-MC and ChCl: OAD-MC treatments respectively.

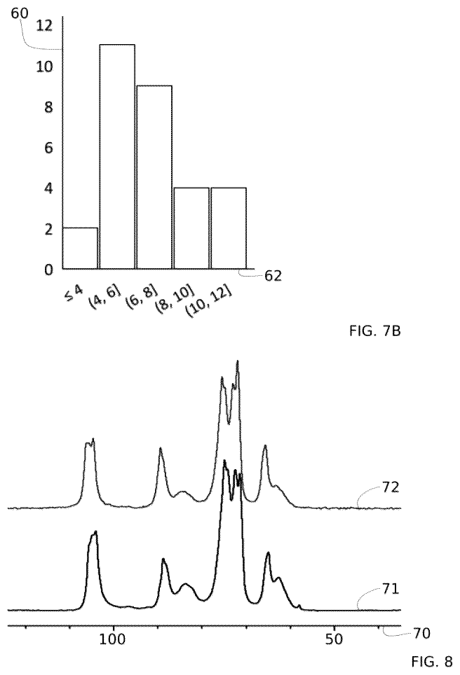

¹³C NMR spectra have been made on cotton fibres 72 and on CNC-ChCl: OAD-MC 71 after 1.5 hours of grinding, as illustrated by FIG. 8. The abscissa axis corresponds to the chemical shift 70 in ppm. The ¹³C NMR spectra have been carried out on a Avance® III 400 MHz spectrometer at a temperature of 298 K. The apparatus was equipped with a cross-polarisation, high-power proton decoupling and magic angle rotation (CP-MAS), and the rotational speed of the sample is 12,000 Hz. The acquisitions have been performed over a spectral width of 29 761 Hz with an acquisition time of 36 ms and 7,400 scans.

The two spectra are characteristic of a cellulosic sample. The observed peaks may be attributed to the different carbons of the anhydroglucose unit with the contribution of C1 (103.8 ppm), C2, C3 and C5 (combined in the large peak around 74.4 ppm), C4 (81.9 ppm for the cellulosic fibres 72, 88.9 ppm for the CNC 71), and C6 (61.5 for the cellulosic fibres and 64.7 ppm for the CNC 71). An additional peak is present at 57.87 ppm, which could be associated with residual choline chloride.

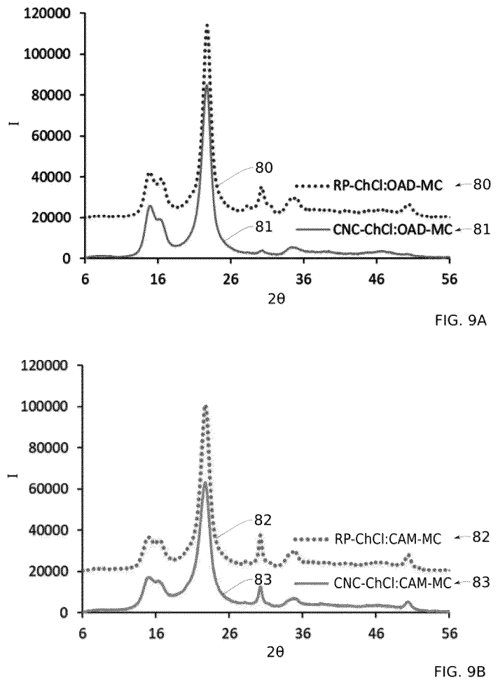

FIGS. 9A and 9B show the X-ray diffraction patterns for:
80: the residual fibres RP obtained after the ChCl: OAD-MC treatment,
81: the CNCs obtained after the ChCl: OAD-MC treatment,
82: the residual fibres RP obtained after the ChCl: CAM-MC treatment,
83: the CNCs obtained after the ChCl: CAM-MC treatment.

The crystallinity index (CI) is calculated by the Segal method after 1.5 hours of mechanochemical treatment at 30 Hz, with the NADES ChCl: OAD and ChCl: CAM. This consists of an empirical method which enables a rapid comparison between the cellulosic samples. The CI has been calculated after subtraction of the bottom from the ratio between the height of the peak (1002) and the height of the minimum (I_{AM}) located between the peaks 002 and 101, as set out in the following equation. The measurements have been carried out in the dry cellulosic samples (overnight, 105° C.) using an X'Pert Pro MDP instrument (Malvern Panalytical®) in the reflection mode with the Bragg Brentano geometry. The anode was composed of copper, and the wavelength was 1.5419 Angstrom.

$$CI ( \% ) = \frac{{I}_{002} - {I}_{A M}}{{I}_{002}} \times 100$$

All of the studied samples have the characteristic diffractograms of the arrangement of the cellulose I. The initial CI of the cotton cellulosic fibres is 92%. The CNCs obtained after the ChCl: OAD-MC and ChCl: CAM-MC treatments have a crystallinity of 93% and 87%, respectively. In comparison, the CI values of the residual particles obtained after ChCl: OAD-MC and ChCl: CAM-MC are 94% and 93%, respectively. The CNCs of the ChCl: CAM-MC treatment have a lower crystallinity than for the ChCl: OAD-MC treatment. It should be noted that the additional peak at 30,2 2θ corresponds to a contamination with zirconium dioxide during the mechanochemical treatment.

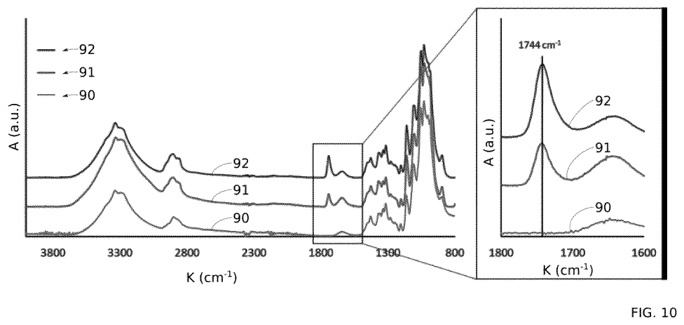

In FIG. 10, FT-IR absorbance spectra (Fourier Transform-InfraRed spectroscopy) as a function of the wavenumber k have been obtained for:
90: the cotton cellulosic fibres,
91: the CNCs obtained after the ChCl: CAM-MC treatment,
92: the CNCs obtained after the ChCl: OAD-MC treatment.

The FT-IR spectra are obtained using a Perkin-Elmer Spectrum 65 instrument (PerkinElmer®, USA). This technique is used to determine an esterification between the cellulose and the organic acids. Given the proximity between the carbonyl peak and the ester peak (respectively, ≈1,720 cm⁻¹ et≈1,740 cm⁻¹), each sample has been basified using an NaOH solution to convert the carboxylic acid groups into carboxylate groups (about 1,600 cm⁻¹) and dried at room temperature overnight before the analysis. The spectra have been recorded in attenuated total reflectance (ATR, standing for Attenuated Total Reflectance in English) mode between 4,000 and 600 cm⁻¹ with 16 scans and normalised for a better comparison. At least two measurements have been performed per sample.

The FT-IR spectra of the cotton fibres 90 have the conventional absorption peaks for a cellulosic material with a peak at 1,640 cm⁻¹ due to the adsorption of water. The CNCs obtained by the mechanochemical treatment have an additional peak at 1,744 cm 1, related to the C═O elongation. This contribution, associated with a slight increase in the frequency of the C═O elongation, is due to the presence of a layer of water. Combined with a slight increase in the C—H stretch at 2,853 cm⁻¹, this shows the functionalisation of the CNCs by the molecules of oxalic acid and of citric acid depending on the NADES used.

Furthermore, the thermal degradation temperature Td of the cellulose may also be affected by the decrease in the degree of polymerisation and the chemical modification of the surface. Thus, it is known that the introduction of carboxylate groups by TEMPO-mediated oxidation, the post-treatment most used to obtain anionic CNCs, reduces the thermal stability of cellulosic materials. For this reason, the use of CNCs produced from such solutions in bio-nanocomposites is limited.

However, it has been observed that the CNCs obtained by ChCl: OAD-MC and ChCl: CAM-MC treatment have a degradation temperature close to that of the cotton original cellulosic fibres: 338, 337 and 365° C., respectively. These degradation temperatures are similar to those obtained for the CNCs produced by molten oxalic acid and those reported in the literature for the ChCl: OAD treatment with no mechanochemical treatment. In comparison, the CNCs obtained by acid hydrolysis H₂SO₄ have a degradation temperature of 303° C. under the same conditions.

The table hereinbelow summarises the results obtained for each sample.

TABLE 4

| | Mass yield | Cl | Length | Td | ζ |
|---|---|---|---|---|---|
| Sample | (wt %) | (%) | (nm) | (° C.) | (mV) |
| Cotton cellulosic | NA | 92 | NA | 364 | NA |
| fibres | | | | | |
| CNC-ChCl:OAD-MCₐ | 65 ± | 93 | 143 ± | 337 | −42.0 ± |
| | 5 | | 28 | | 3.3 |
| CNC-ChCl:CAM-MC a | 27 | 87 | >400 | 335 | −41.2 ± |
| | | | | | 1.6 |

In view of the previous description, it clearly appears that the invention offers an improved method for manufacturing cellulose nanocrystals, and in particular a method that is more suited to industrial manufacturing constraints, for example in terms of treatment time, temperature and/or cost.

The invention is not limited to the previously-described embodiments and extends to all of the embodiments covered by the invention. The present invention is not limited to the previously-described examples. Many other variants are possible, for example by combining previously-described features, without departing from the scope of the invention. Furthermore, the features described with regards to one aspect of the invention may be combined with another aspect of the invention.

1. A method for manufacturing cellulose nanocrystals comprising:
providing a deep eutectic solvent obtained by mixing a quaternary ammonium salt and a hydrogen bond donor compound, the hydrogen bond donor compound being able to form the deep eutectic solvent with the quaternary ammonium salt,
in a mechanochemical reactor, forming a reaction medium comprising cellulosic fibres and the deep eutectic solvent,
subjecting the reaction medium to a mechanochemical treatment so as to obtain cellulose nanocrystals of the cellulosic fibres.

2. The method according to claim 1, wherein the quaternary ammonium salt is choline chloride.

3. The method according to claim 1, wherein the hydrogen bond donor compound comprises at least one carboxylic acid group.

4. The method according to claim 1, wherein the hydrogen bond donor compound comprises at least two carboxylic acid groups.

5. The method according to claim 4, wherein the hydrogen bond donor compound is selected from the group consisting of citric acid and oxalic acid.

6. The method according to claim 4, wherein, upon completion of the mechanochemical treatment, the cellulose nanocrystals have an amount of carboxylate group comprised between 100 and 3,000 μeq/g of cellulose nanocrystals.

7. The method according to claim 1, wherein the mechanochemical treatment is performed for a duration shorter than or equal to 2 hours.

8. The method according to claim 1, wherein the formation of the reaction medium is performed at a temperature comprised between 15° C. and 30° C.

9. The method according to claim 1, wherein the mechanochemical reactor is a mechanochemical mill, for example a bead mill.

10. The method according to the preceding claim 11, wherein the mechanochemical treatment is performed at a vibration frequency comprised between 5 Hz and 50 Hz.

11. The method according to claim 1, wherein, after the mechanochemical treatment, the method comprises washing the reaction medium.

12. The method according to claim 14, wherein the washing is done by dialysis of the reaction medium through a dialysis membrane.

13. The method according to claim 1, wherein, upon completion of the mechanochemical treatment, the reaction medium comprises a mass fraction of cellulose nanocrystals higher than or equal to 20%.

14. The method according to claim 1, wherein, after the mechanochemical treatment, the method comprises separating the reaction medium into a first fraction comprising the cellulose nanocrystals and a second fraction comprising residual fibres.

15. The method according to claim 18, wherein the separation of the reaction medium comprises centrifuging the reaction medium followed by sampling one amongst the first and second fractions.

16. The method according to claim 18, wherein the second fraction is recovered for use thereof in a method for manufacturing cellulose nanofibres.

17. The method according to claim 5, wherein the hydrogen bond donor compound is oxalic acid.

18. The method according to claim 7, wherein the cellulose nanocrystals have an amount of carboxylate group substantially equal to 1,500 μeq/g.

19. The method according to claim 12, wherein mechanochemical treatment is performed at a vibration frequency substantially equal to 30 Hz.

20. The method according to claim 16, wherein the reaction medium comprises a mass fraction of cellulose nanocrystals higher than or equal to 40%.
